(19) United States
(12) Patent Application Publication
(10) Pub. No.: US 2007/0073610 A1
(43) Pub. Date: Mar. 29, 2007

(54) JOB AUCTION METHOD AND SYSTEM

(76) Inventors: Prasad Marugabandhu, Apollo, PA (US); Rahmi Marasli, Mars, PA (US); Siddartha Narasimhan, Gibsonia, PA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/470,874

(22) Filed: Sep. 7, 2006

Related U.S. Application Data
(60) Provisional application No. 60/714,796, filed on Sep. 7, 2005.

(51) Int. Cl. G06Q 40/00

(52) U.S. Cl. 705/37

(57) ABSTRACT

An online auction system enables a consumer to post job description for a job, a second module that enables a plurality of service providers to view the job description and submit a proposal to the consumer for performing the job, and a third module that enables the consumer to select a proposal from one of the service providers. The system may enable the service providers to request additional information about the job from the consumer, and enable the service providers and consumers to interact by modifying the job description and modifying bids based on job description modifications. In some embodiments the system also may provide a job posting template and a payment module.

### RELATED APPLICATIONS AND CLAIM OF PRIORITY

This application claims priority to pending U.S. provisional patent application No. 60/714,796, entitled “Job auction method and system”, filed Sep. 7, 2005, which is incorporated herein by reference in its entirely.

### BACKGROUND

1. Technical Field

The embodiments described in this document relate to service auction methods and systems.

2. Description of the Related Art

Online auctioning is a successful and widely used e-commerce application on the Internet. There are many companies, that provide online auctioning of goods, such as eBay and Bid.com. These companies provide a platform for online auctioning of goods and charge a nominal fee for using their services. A common online auction service uses an English auction model where the highest bidder wins the rights to buy the auctioned goods at the corresponding bid price.

There are also online sites that provide job postings and obtain regular quotes or bids for white collar jobs, mostly software and web related jobs. These sites are usually a front-end to off-shoring (or out sourcing) jobs to overseas. The principal auctioning process provided by these sites and systems is based on a sealed bidding/quote submission model where the lowest bidder wins or has a greater chance to win the right to perform a task in exchange for receiving the corresponding bid price as the payment.

The current systems provide no effective ability for providers of many local or hands-on, blue collar jobs, such as tutors, lawn services cleaning services, in-home contractors and others to connect with consumers who need their services. This document describes an attempt to solve such problems with a method and system that allows people who provide hourly, duration or project-based work to connect with people who need them.

### SUMMARY

In accordance with one embodiment, an online auction system includes a first module that enables a consumer to post a job description for a job, a second module that enables a plurality of service providers to view the job description and submit a proposal to the consumer for performing the job, and a third module that enables the consumer to select a proposal from one of the service providers. Optionally, the second module also enables the service providers to request additional information about the job from the consumer. Optionally, the second module enables the service providers and consumers to interact by modifying the job description and modifying bids based on job description modifications. Optionally, the first module provides the consumer with a job posting template. The system also many include a payment module that processes payment from the consumer to the service provider who submitted the selected proposal. The payment module may release the payment in increments after the selected service provider meets one or more milestones. The system also may include a feedback module that enables consumers to submit and view feedback regarding service providers.

In another embodiment, s method of auctioning a local service includes: (i) receiving, from a consumer, a job description; (ii) presenting the job description to a plurality of service providers; (iii)receiving a plurality of service provider bids; (iv) presenting one or more of the bids to the consumer; and (v) selecting a winning bid from one or more of the bids, Optionally, the receiving a plurality of service provider bids includes: (i) receiving, from a service provider, a request for additional information, (ii) delivering the request to the consumer; (iii) receiving a revised job description or additional information from the consumer in response to the request; and (iv) receiving a bid from the service provider based on the revised job description or additional information. Optionally, the method also includes, after receiving the job description, accessing a database of service providers to identify one or more qualified service providers who meet one or more criteria that relate to the job description, and inviting the qualified service providers to submit bids in response to the job description. Optionally, the inviting is performed via telephone or electronic mail. Optionally, the selecting includes: (i) identifying, by the system, a plurality of qualified bids from the received service provider bids; (ii) presenting, by the system, the plurality of qualified bids; and (iii) receiving, from the consumer, a selection of the winning bid. The method also may include processing payment from the consumer to the selected service provider when the service provider meets a job milestone. The presenting may include enabling the consumer to view qualifications and feedback relating to the service providers who submitted the bids, and after the selecting, receiving from the consumer feedback relating to the selected service provider. The method also may include offering, to the consumer, liability insurance relating to the job description. The receiving may include receiving a consumer selection of a job description template; receiving, via the selected template, text describing a job; receiving, via the selected template, a photo, illustration or video describing the job; and receiving, via the selected template, a geographic location of the job. The template may be specific to a job category. The method also may include enabling a plurality of selected service providers to search for job descriptions based on geographic location and job category.

Alternatively, a method of auctioning a local service includes: (i) receiving, from a con slimier, a job description; (ii) accessing a database of service providers to identify one or more qualified service providers who meet one or more criteria that relate to the job description, wherein the criteria include geographic location; (iii) inviting the qualified service providers to submit bids in response to the job description; (iv) presenting the job description to the qualified service providers; (v) receiving a plurality of service provider bids, wherein at least one of the bids is a conditional bid; (vi) receiving additional information or a revised-job description from the consumer in response to the conditional bid; (vii) receiving a conversion of the conditional bid to a binding bid; (viii) presenting one or more binding bids to the consumer; and (ix) selecting a winning bid from one or more of the binding bids.

### BRIEF DESCRIPTION OF THE DRAWINGS

FIG. 1 is a block diagram-illustrating exemplary elements of a job auctioning system.

FIG. 2. is a process flow diagram illustrating exemplary elements of a job auctioning system.

FIG. 3. is a process flow diagram illustrating exemplary elements of closing and payment procedures of a job auctioning system.

FIG. 4 is a block diagram illustrating exemplary components of a computer system.

### DETAILED DESCRIPTION

In the followings description, numerous details are set forth in order to provide a thorough understanding of the invention. It will be apparent, however, to one of ordinary skill in the art, that the invention may be practiced in various ways without limitation.

It must also be noted that as used herein and in the appended claims, the singular forms “a”, “an”, and “the” include the plural reference unless the context clearly dictates otherwise. Unless defined otherwise, all technical and scientific terms used herein have the same meanings as commonly understood by one of ordinary skill in the art. Although any methods similar or equivalent to those described herein can be used in the practice or testing of embodiments of the present invention, the preferred methods are now described. All publications and statistical data mentioned herein are incorporated by reference, As used herein, the word “comprising” means “including but not limited to” Nothing herein is to be construed, as an admission that the invention is not entitled to antedate such documents or data.

This document presents an online auctioning mechanism for jobs such as personal services or blue collar jobs. For the purposes of this document, we will use the following definitions:

Job: Any blue collar, in-person, locality-sensitive or similar job. Some examples of such jobs include (but are not limited to) or office home construction and improvement, home or office cleaning, landscaping, baby sitting, nanny services, HVAC (heating, ventilation and air conditioning) installation and repair, tutoring and others. These jobs are almost always local in nature and are not suitable for off-shoring or out sourcing to another physical location.

Consumer: Any person or other entity who can offer a job. In other words, a consumer requires services to be provided by a provider,

Provider: Any person or entity who can fulfill a job. In other words, a provider of services may fulfill jobs offered by consumers.

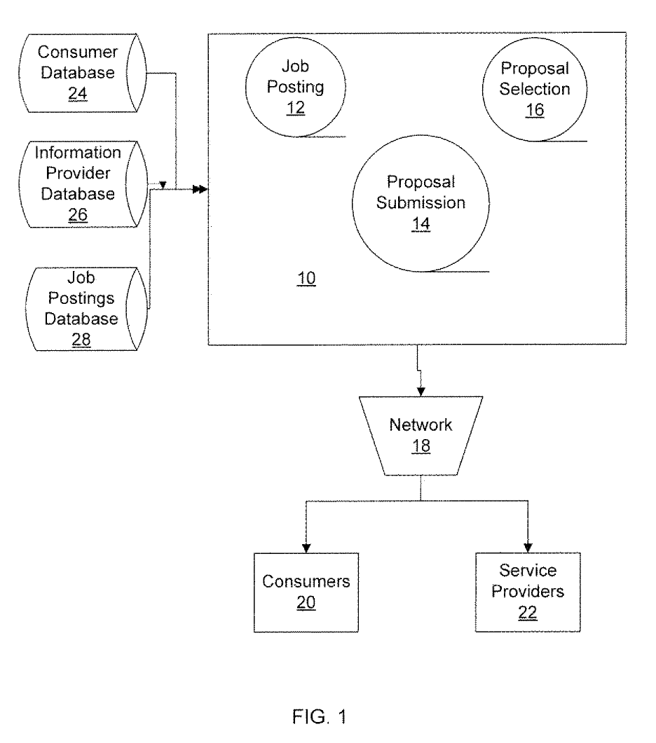

In an embodiment, referring to FIG. 1., a job auction system 10 may include one or more computers containing a job posting module 12, a proposal submission module 14, and a proposal selection module 16. The system 10 may be accessed by consumers 20 and service providers 22 a plurality of computer system telephones, personal digital assistants (PDAs) or other communication-enabled electronic devices connected via a communication network 18 such as the internet. The system 10 contains or has access to a database of consumers 24 and/or services registered in the system. Any new consumer wishing to place a bid or initiate an auction on the system must register with the system. A registered user can use the system after the system authenticates his/her registration information, such as with a login name and password.

Similarly, there may be a database 26 that includes information providers who are registered in the system. In some embodiments, a provider may also be a consumer of jobs provided by another provider. Hence, in some embodiments, any registered provider will have all rights and privileges of a consumer.

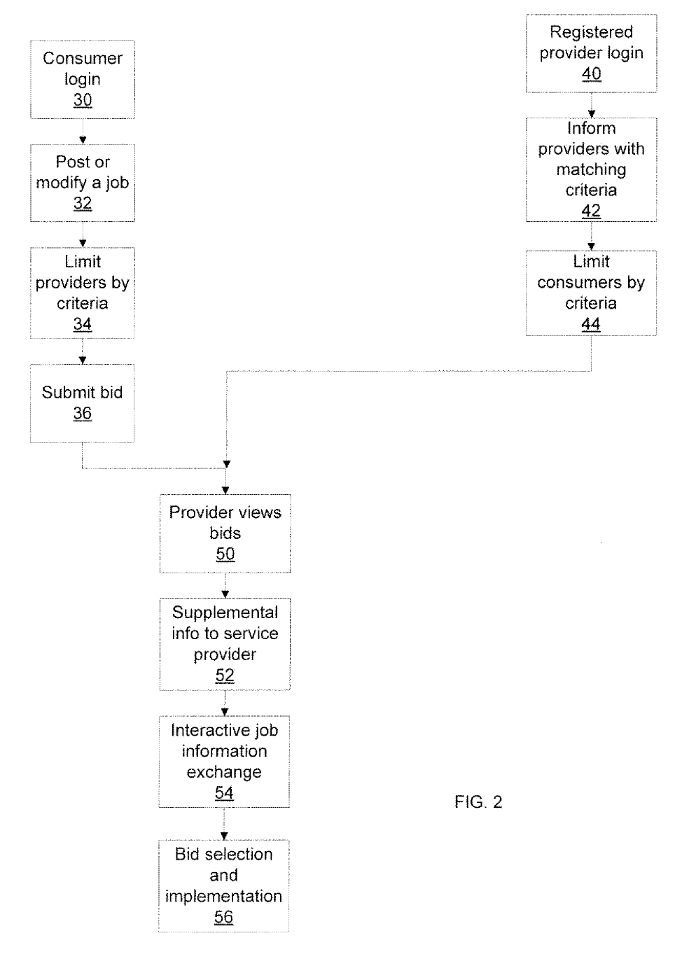

FIG. 2 illustrates exemplary processes that may be implemented by a job auction system. A consumer may login 30 and the system may authenticate his/her registration information, such as with as with a login name and password. After login 30, a consumer can post a new job posting or modify an existing job posting 32. Each new job posting may initiate a new auction in the system. Optionally the system may have a database of all job postings (28 in FIG. 1).

A job posting will include a job description. In some embodiments, one or more job posting templates may be used using methods such as those described in the “Customized Job Description Templates” section of this document. Optionally the job posting templates may be customized to a job category, such as “home renovation contractor” or “landscaping service”. Depending on the job category tie description may include, but is not limited to, an overall description of the job, with or in the form of any text, picture, drawing, audio video, or any other material that can be used to describe job and that can be encoded and communicated electronically using computers or other electronic communication devices. For example, a movie-style walk through of a job site may be included with the job description,

A job description may also include information such as an address and/or zip code of the job location a start and stop time and/or date for a job; the form or of payment that the consumer will accept; optional times when the consumer may be available to assist the job; an automatic municipality and/or building code or zoning reference, such as a hyperlink or a system for accessing a database, based on the address and/or zip code of the property; a distance calculation of the product provider to the job; Exterior pictures and route access to job site; and an option to access additional information. Optionally, the consumer may be permitted to upload as much job description as desired. An alternate embodiment, the consumer may be permitted to upload a base amount of data, such as two megabytes, for free or for a base fee, with additional data requiring an additional charge.

In some embodiments, a consumer may limit 34 who can bid on his/her posted job using a technique such as those described in the “Consumer Driven Bidder Selection” section of this document below. In some embodiments, the consumer may request criminal and/or credit background checks on potential providers, and the consumer may limit bidders to only those providers with a certain level of credit worthiness and/or a clean criminal background. For this, techniques such as those described in the “Consumer/Provider Criminal Background Checks”, and “Consumer/Provider Credit Background Checks” sections of this document may be used.

If a consumer has an emergency or rush job that needs to be done quickly or immediately, in some embodiments he/she may take advantage of an expedited auctioning 36 method such as that described in the “Emergency Job Auction” section of this document

A registered provider 40 can use the system after the system authenticates his/her registration information, such as with a login name and password. As part of a registration process, a provider can indicate whether or not he/she wants to be informed when new jobs matching his/her skill level are posted through methods such as those described in the “Provider Alert Technique” section in this document below. After a job is posted, any provider with matching criteria may be informed 42 via the system through notification methods such as those described in the “Provider Alert Technique” section of this document. In some embodiments, a provider may also find suitable jobs via various search mechanisms in the system. This may include a keyword search and/or browsing of jobs based on categories. This may also include searching jobs based on geographic location, using a method such as that described in the “Zip Code and Geographic Based Search” technique of this memo.

After a provider finds a job that is of interest, he or she may be provided the opportunity to bid on it 46. In some embodiments, before bidding on a job, a provider may request criminal and/or credit background checks on consumers, or otherwise limit consumer acceptability criteria 48, using techniques such as those described below. In some embodiments, the system may only permit bidding to start when a predetermined number of providers have registered to bid on a job. Also, optionally the number of bidders on a job may be limited.

When a bid is submitted, it may be conditional or binding. A conditional bid may be a bid that is conditioned on receipt of additional information from the consumer and/or on the consumer's agreement to one or, more conditions submitted by the service provider. A bindings bid may be one that the service provider considers to be final. A conditional bid may he considered inactive and remain so until it is either abandoned or turned into a binding bid by the service provider. After receiving additional information in response to a conditional bid or request for information, the service provider may be permitted to change (increase or decrease) the bid amount or withdraw the bid. Optionally, the conditional bid may be cancelled by the system if the service provider does not convert it to a binding bid within a predetermined time period.

After a bidder submits a bid, in some embodiments the bidder may be permitted to modify or retract the bid. Optionally, retraction or bid increase may be prohibited in a predetermined time period before end of auction (such as two hours). Optionally, retraction of a bid may result in a bid cancellation charge.

After one or more service providers bid on the job, the consumer may be permitted to view and compare the bids 50. The consumer may be permitted to perform criminal and/or other background checks on providers before deciding whether to accept a bid from a provider 52. Alternatively or in addition, as noted above, provider selection criteria may be established 34 to ensure that only qualified bidders are permitted to bid on a project. Examples of selection criteria may include consumer satisfaction ratings, credit ratings, background checks, credit worthiness, distance from job location, years of experience, formal education, other projects taken and/or completed on the system, and other items. Such criteria may be predetermined, or they may be user selectable. In such an embodiment the system will only allow providers meeting the criteria to bid on the auctioned job. Also optionally, the consumer or auction initiator may be permitted to invite specific bidders to participate in an auction.

In some embodiments, it may possible for a provider to request more job related information from the consumer, thus providing an interactive exchange of job-related information 54. For example, the provider may require more detail about the job, such as duration, location or job scope, in order to provide a bid. This may be done using suitable techniques such as those described in the “Interactive Job Information Request” section of this document. The bidder may also be permitted to submit a conditional bid, in which the service provider submits a price and certain conditions or variations not expressly listed in the job description. In some embodiments there may be a “job announcement period” 35 before bidding starts where perspective bidders can seek clarification of job-related information. Optionally, a potential or actual bidder may be permitted to physically visit the jobsite to better understand the auctioned job. If no interest is shown during the announcement period, the system may prompt the consumer or auction initiator to modify the job listing to achieve more interest from bidders. The messages may be stored and presented as part of the job description and may be done online. Also, the job announcement process may require all parties to confirm understanding of the job criteria before bidding on the job is permitted to start.

In addition, in some embodiments interested bidders may be required to register, and an auction may not start until a predetermined number of bidders have registered with the system 45. Thus, in this embodiment the system may ensure that a sufficient number of bidders are interested before starting the auction.

In some embodiments, it may be possible to hide identities of bidders and the amounts of bids in the system using a “Sealed-Auction with Feedback” or “Pure Sealed-Auction with Feedback” techniques such as those described below. The system may also place limitations on bidders using an “End of Auction Bid Limitation” technique such as that described below. In addition in some embodiments before bidding starts or after bidding closes, a contracting process may be initiated whereby each party agrees to the work order. This may be done through a click-through or electronic signature process to ensure that the completion of the auction results in a binding legal agreement.

In some embodiments, bidding may continue over a time period selected by the consumer or the system such as 24 hours, 48 hours, or another time period. Also, bidding may be permitted to continue until a predetermined low bid is reached. Also, optionally, no bids may be accepted unless they are below a predetermined maximum limit. Such a maximum bid price may be listed in the job description in some embodiments.

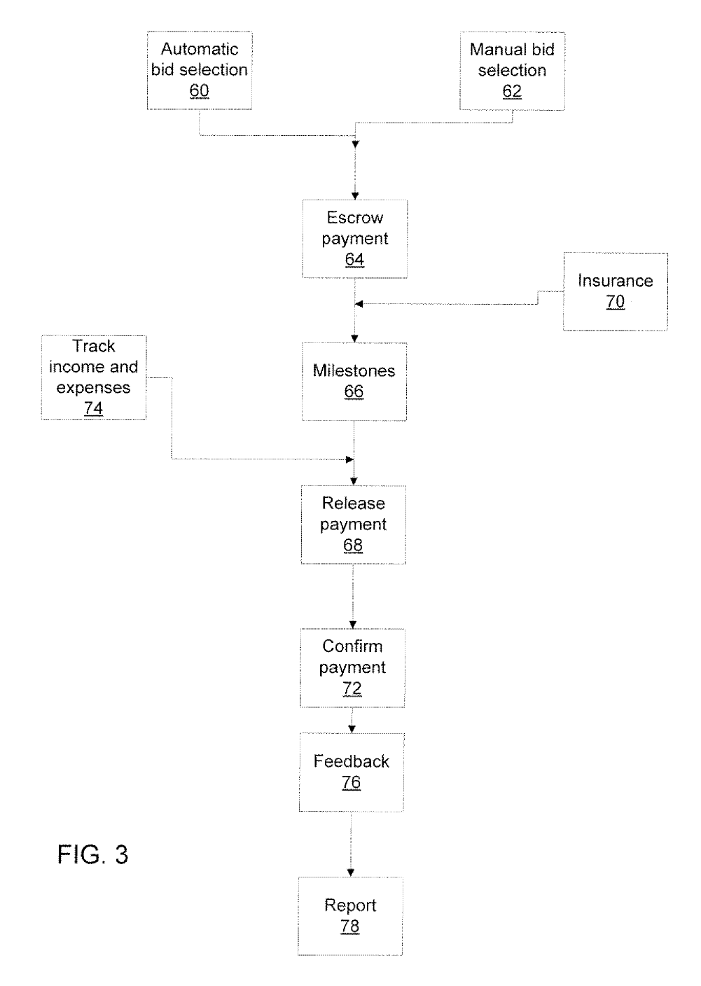

In some embodiments, bid selection 56 may be performed in accordance with one or more procedures. FIG. 3 is a block diagram illustrating several procedures that may be included in various embodiments. For example, the provider with the lowest bid may automatically be chosen as the auction winner by the system 60. In other embodiments, the system may also let the consumer pick an auction winner manually 62. The manual auction winner is not necessarily the lowest bidder, as the consumer may wish to consider other factors, such as personal experience, qualifications of the contractor, feedback from other consumers, location and/or other factors. A combination of procedures may be used, such as an embodiment where the system automatically reduces the number of bids to a list of those bids meeting predetermined criteria, and the consumer may then select a winning bid from a list of the qualified bidders. Optionally, the consumer may be required to select one of the qualified bids, Alternatively, the consumer may be free to reject all bids if the consumer so desires.

The bidding price represents the payment a provider would be willing to receive after successful completion of the auctioned job. Optionally, a maximum project may be set suchaffaf that no bid over a maximum will be accepted for the auction. Alternatively, a bid over the maximum may be accepted and displayed by the system without be binding unless confirmed by both parties. As an additional option, the auction initiator may establish a “service now” price or “auction close”price as part of the job description creation (32 in FIG. 2) whereby any bid with this price is instantly declared the winning bid and the auction immediately closes.

Optionally, if two or more bids of the same value are placed and the consumer does not select one of the bidders, the system may automatically select the first bid placed as the winning bid. Also optionally, if a bidder withdraws a bid, once submitted, the bidder may be penalized by the system or given negative readings in any consumer rating area.

Optionally, the provider or consumer may be given the opportunity to request an escrow service to hold payment by the consumer 64. The escrow service may require submission of actual funds from the consumer, or it may simply hold a consumer's credit card number and charge the consumer's when payments are due. The on-line system may include an interface where the consumer and provider can establish and/or negotiate milestones for project, payment and completion 66. When both parties are in agreement that a project has been completed or a project milestone has been achieved, the escrow service may release funds to the provider 68. Alternatively, the milestones and payment terms may be part of the initial proposal submission. Also additionally the provider or insurer may be provided the opportunity to purchase liability insurance 70 via a on-line or other service for the project.

After the provider services the auctioned job, in some embodiments the system will enable the provider and/or the consumer to confirm the final payment for the job 72. This may be done for example, using the “Double Confirmed Job Payment” of this document

In some embodiments, the system may also provide an accurate income and expense tracking mechanism for the providers 74. Exemplary details such as feature are defined at the “Provider Income Tracking” technique of this document.

After a job is serviced by a provider, in some embodiments the consumer may receive the opportunity to give feedback on and rate on the provider 76. The system may keep track of feedbacks and ratings using the “Multi-variable Feedback Mechanism” technique off this memo.

In some embodiments, the auction winner and/or auction initiator may receive one or more post-auction reports 78. The post-auction report for the auction initiator may include information such as auction identification; congratulatory message; winning bid amount; winning bidder, optional contact information for the winning bidder; related auction service charges; link to a provider feedback form; a consumer satisfaction feedback form; an auction closure tracking form; tax-related forms; forms and/or links for purchasing insurance; forms and/or links for setting up an escrow with a milestone-based escrow payment released. Similarly, the post-auction report for the auction winner (i.e., the service provider) may have similar types of information, except that contact information and feedback would relate to the consumer. Also optionally, once the job is completed, the consumer and/or provider may be required to confirm some or all of the information on the form.

If no one bids for a job that is posted, the system may offer the auction initiator the opportunity to modify the listing and re-list the same and/,or a modified auction for no additional charge or for a fixed charge.

I. Interactive Job Information Request Technique (also know as Dynamic RFQ)

There are various challenges in providing an online auctioning service for blue collar, service level mid other geographically-limited jobs. Firstly, the description of the job posting has to be complete enough for providers so that they can start bidding. Within the context of this document, a job description may include, but is not limited to, any text, picture, drawing, audio, or any other material that can be used to describe a job and that can be encoded and communicated electronically using computers.

Describing sonic jobs maybe straight forward and not require any sophistication. There are, however, many jobs where an ordinary consumer may have difficulty describing them with enough detail. If the description of the job is not clear enough, the providers may be reluctant to participate in the auction. Even when providers bid on these jobs, the auction may not be meaningful since the actual job may be different than the one described at auction posting.

To overcome the unclear job description challenge, an interactive job information request technique may be implemented. In this technique, the consumer submits the initial description of the job for providers to bid. Then providers will have various options, such as the following choices:

No interest. Provider does not have any interest in the job posting.

Make Bid. Provider clearly understands the job description has strong interest in it and makes a binding bid.

Make a Conditional Bid. Provider does not fully understand the job description. However, he/she still has interest in fulfilling the job. A bid is offered with a clarification request on the job description. A conditional bid will be considered inactive and remain so until it is either explicitly abandoned (i.e., cancelled) or turned into a binding bid by the bidder. Hence, a conditional bid is not binding and not considered while determining the winning bid for auctions. Optionally, conditional bids may be given a time period within which they will either expire or be turned into binding bids if not changed within the time period. Optionally, a provider may be permitted to change the value of a conditional bid upon receiving more information or other circumstances. Optionally, a bid may include both time and materials, or the system may require the bidder to provide separate bids for separate elements of the project, such as project stages, time and/or materials.

Request More Information. Provider has some interest in the job but the job description is vague. More information from the consumer is requested.

The consumer can optionally provide extra information for the “conditional bid” and “request more information” choices. Once the consumer provides the requested information, a provider with a conditional bid can change his/her bid into a blinding, one, or the provider may abandon it by canceling:, it. Similarly, a provider with an information request can make a bid if he/she is satisfied with the extra information and still has an interest in the job. Once an auction expires, all conditional bids also expire with it.

This technique is provided as an interactive process between the consumer and provider as pan of the online auctioning. As a result, if a vital piece of information is missing from the job description, the providers can request it from consumer before making any bids. Overall, providers may have more expertise in describing jobs, and they can guide consumers via this interactive process,

II. Consumer Driven Bidder Selection Technique

As another challenge, there is the problem of ensuring, that only the qualified providers will bid on a job. The system should be versatile enough for a consumer to specify who is qualified to perform the posted job. Otherwise, the consumer can end up with an undesirable provider. Without a solution to this challenge, the consumers will be reluctant to post their required jobs for auctioning,

To overcome this challenge, in some embodiments the system implements a consumer driven provider selection process. As part of job posting, the system may prompt the consumer to specify qualified provider criteria. Some examples of these criteria include (but are not limited to) the following: credit rating, background check, years of experience, formal training, etc. This criterion may also include a consumer feedback rating based on the “Multivariable Feedback Mechanism” technique described below. The system thus may ensure that only those providers that fulfill the consumer specified criteria can bid on the job.

In some embodiments, the consumer can select the type of search request or auction and can pick from cases such as reverse auction, pure sealed, plain sealed, etc.

Optionally, the consumer may also be permitted to select certain bidders to invite to the auction. Such service providers may be selected based on the consumer's personal knowledge, or based on information contained in a service provider database. If bidders are invited, the system may alert the invited service providers about a job when posted. Also, even if the consumer does not select bidders to invite, the system may optionally invite all bidders who meet certain qualifications. Such as geography, technical skills, years of experience or other information, to invite on a job when posted.

III. Consumer/Provider Criminal Background Check Technique

There are certain jobs such as baby-sitting where consumers will be highly concerned with finding a trusted and qualified provider. For those cases, in some embodiments the system will provide background check capability for both consumers and providers. This may include criminal background cheeks to ensure that the providers halve a clean record, no arrest records, etc.

To implement criminal background checks, the auctioning system may interface with external, third-party systems that perform background checks. In some embodiments, consumers may use criminal background checks to another restrict providers that can bid on their jobs.

In some embodiments, providers can have a background check done as part of their registration process or even at a later time after registration. Providers with a completed background check will be displayed in the system. This display may include for example, different levels, such as three different flags: red, yellow and green. A red flag indicates that the provider does not have a clean background and was involved in more than one offense. A yellow flag indicates that the provider does not have a clean background but has not been involved in any major offenses. And finally, a green flag indicates that the provider has a clean background.

IV. Consumer/Provider Credit Check Technique

For credit cheeks, the system may interface with external systems that perform credit checks. This may be provided to ensure that the consumers have good credit and make prompt payments. This may be used for providers to restrict consumer projects that they can bid on.

This may be especially useful for larger projects, where the amount of labor and fees are much higher. The fact that the consumers have good credit can put the providers at ease and make them more geared toward bidding on the project.

In some embodiments, credit checks will be available in the system to both providers and consumers and both parties can use these checks.

V. Sealed-Auction with Feedback Technique (Also Called Sealed-Feedback Auction)

Any online auctioning system may be a bid-sniping problem. In bid-sniping, a predatory bidder waits until just before the auction expires to make a favorable bid for him/her. This leaves an auctioneer possibly accepting a bid that is not necessarily the most advantageous to him/her. If the auctioneer notices bid-sniping activity, then in the prior art he/she could cancel the auction and possibly face an auction cancellation charge. These are not fair choices to the auctioneer. Bid-sniping can eventually erode the trust in the whole system and it is a hindrance to the wide-spread acceptance of auctioning systems.

Another common problem with online job auctioning systems is bid-gaming. In bid-gaming, a bidder may actually submit a high-bid just to see how the competition reacts. This makes other bidders hesitant in participating in the auctioning process. Bid-gaming can actually lead to a higher price than one that could have been obtained via traditional methods such as direct quotes or sealed-bids.

To protect against bid-sniping and bid-gaining problems, in some embodiments the system may provide a blind-auctioning with feedback mechanism. This technique will hide bid amounts from all bidders. During the auction, in this embodiment the bidders will only be allowed to see their own bids and whether or not theirs is the winning bid (lowest bid). This techniques will ensure the privacy of each providers' bid. A providers can comfortably bid on jobs without the fear of having the competition know their bid. A provider with a losing bid will be motivated to lower his/her price and re-bid. This will, in turn, help consumers get a lower possible price for their jobs and also help ensure that the provider does not under bid the job due to competitive pressure.

This technique may also address the bid-sniping problem since a predatory bidder will not know the exact price for the winning bid and cannot possibly make a bid to take advantage of an expiring auction.

Variations in the sealed bidding with feedback may include some or all of the following:
The providers may have feedback on whether their bid is the highest or not, but the auction initiator cannot see the current bid prices and has no clue what price the auction is at. The auction initiator will only know at the end.
A subset of this where the auction initiator knows the ranks of the provider bidders, but does not know the value of the bids.
Another subset where the auction initiator knows the lowest bid amount but does not know who is the bidder. He knows that the bidder has the experience and meets the bidder selection criteria. This may help the auction initiator from making a non biased call on who to pick, as he does not know who the provider actually is.
Feedback may let the providers know if their bid is the lowest (winning) or not. There may also be ranking based on feedback.
   VI. End of Auction Bid Limitation Technique

To further protect against bid-sniping, some embodiments of the system may provide a time limit or an upper limit on the number of times a provider can bid on a given job just before an auction expires. In general, the time limit and the number of times a provider is allowed to bid will be consumer configurable. As defaults, the system may limit a provider to a single bid within 15 minutes of the auction expire. However, other numbers and time frames may be used. This limitation may further motivate providers to make their most competitive bids during this period, and it may result in further gains for the consumers. Also, rules may be set for the number of bids a provider can make during a certain time frame (for example—2 bids per hour).

There may be a “service now” or “auction close” price, which may be linked with the bidder/provider pre selection criteria module so only those qualified bidders will be allowed to even do the “service-now” price. The consumer may be permitted to sets up criteria for providers who can participate in an auction using the bidder selection module and then posts the job, so that only those qualified can bid or service now.

The bidding price represents the payment a provider would be willing to receive after successful completion of the auctioned job. Optionally, a maximum project may be set such that no bid over a maximum will be accepted for the auction. Alternatively, a bid over the maximum may be accepted and displayed by, the system without be binding unless confirmed by both parties. As an additional option, the auction initiator may establish a “service now” price or “auction close” price as part of the job description creation (32 in FIG. 2) whereby any bid with this price is instantly declared the winning bid and the auction immediately closes.”

VII. Pure Sealed-Auction with Feedback Technique

This technique takes “Sealed-Auction with Feedback” technique further by completely closing the bids to not only bidding providers, but also the auction initiator. This is useful when there is a danger of leaking winning bid to a select set of providers by the consumers. Such leaks can happen, for example, when the auction initiator is an entity/organization such as a homeowners association. In this case, some members of the association might leak current winning bid price to his/her friends/relatives. This will create an undue disadvantage for other providers. As a result of this, a homeowners association might actually end up receiving a non-competitive bid.

In this technique, bids from qualified providers may be kept hidden from providers. Once a provider submits a bid, he/she will be informed whether or not his bid is the winning bid. The bidder's identity and their bid prices will be kept secret from the auction initiator as well. The system will determine the lowest bidder as the winner, and inform consumer and, winning provider when the auction time expires.

Variations in tie pre-sealed auction with feedback may include some or all of the following:
The providers may have feedback on whether their bid is the highest or not, but the auction initiator cannot see the current bid prices and has no clue what price the auction is at. The auction initiator may only know at the end of the process.
A subset of this where the auction initiator knows the ranks of the provider bidders, but does not know the value of the bids.
Another subset where the auction initiator knows the lowest bid amount but does not know who is the bidder. He knows that the bidder has the experience and meets the bidder selection criteria. This may help the auction initiator from making a non biased call on who to pick, as he does not know who the provider actually is.
Feedback may let the providers know if their bid is the lowest (winning) or not, There may also be ranking based on feedback.
   VIII. Provider Alert Technique

In some embodiments, the system may have a provider alert mechanism. When providers register with the system, they may be asked to indicate whether or not they want to be informed when new jobs matching their skill level are posted. An exemplary provider alert registration may include some or all of the following information:

Job Category List. This is a list of job categories that match the provider's skills.

Geographic proximity of the job. This is defined as a distance in miles from a certain ZIP code or address. This will denote the provider's geographic service area preference.

Alert Mechanism. This can describe the provider's preferred communication method(s), such as e-mail, automatic phone call, paging and faxing.

Once a new job matching a provider's alert criteria is posted, he/she may be notified via the specified alert mechanisms.

When this technique is combined with consumer bidder selection technique, the system will only alert providers that (i) meet consumer driven selection criteria and/or (i) have a matching alert criterion specified by the provider. Optionally, the system may place a limit on the number of providers that can bid on a job, such as ten, so that when ten (or another appropriate number of) providers express interest during, the job announcement period, no other providers will be permitted to bid on the project. Also optionally, if a provider expresses interest or registers as a bidder for a project but fails to submit a bid, the provider may be fined and/or assigned negative ratings and/or feedback on the system.

IX. Emergency Job Auction Technique

From time to time, consumers may have an emergency or rush job that needs to be done quickly or immediately, as the name implies. For such jobs, there will not be enough time to go through a complete auctioning process, which may take days to complete.

For this, in some embodiments the system will provide an emergency job auctioning technique. This auction will be limited in time. Once an emergency job is posted, all providers with matching qualification will be informed via the provider alert technique. Each provider will be allowed to make one and only one bid.

An emergency auction may close upon the occurrence of a predetermined event, such as when one of the following occurs:

Auction time expires. The system will choose the auction winner as the lowest bidder.

All alerted providers submit their only allowed bids. The system will choose the auction winner as the lowest bidder.

Consumer hand picks a winner any time before the above-referenced scenarios. The consumer chosen winner is not necessarily the lowest bidder.

X. Double Confirmed Job Payment Technique.

Once an auction closes, a provider may be assigned to perform the auctioned job. The winning provider may receive the bid amount as the payment after performing the job.

There can be times where the provider finds discrepancies between the posted job description and the actual job to be performed. In those cases, the system may assume that consumer and provider will try to resolve their differences in an offline manner. Assuming there is an agreement between them, the provider will perform the job.

In this case, actual payment for the job may not match the winning bid amount. To ensure that the system can track actual payment, both the consumer and the winning provider may be asked to confirm final payment for the auctioned job.

The provider and consumer may be required to confirm the final payment in the system. Then this auction payment will be treated as authenticated within the system. Such payments will be used to accurately track provider income within the system. This is defined farther in the provider income tracking technique. In an embodiment, a bidding service fee may be deducted before payment is delivered to the provider.

In addition the provider may be required to verify certain information such as proof of insurance and/or bonding; the company name and name, legal status and operation history, and/or insurance company information that can be verified online in real or substantially real time. In addition, the system may be set up as a kiosk such as would occur at a library, career link center, unemployment office or other location. So optionally, providers and/or consumers may be provided access to the system by calling a telephone number that is staffed with people who can upload information into the system that is provided by the caller.

XI. Provider Income Tracking Technique

In some embodiments, the system may provide an accurate income and expense tracking mechanism for the providers. The income tracking may utilize a double confirmed job payment technique. The system may also have a mechanism for providers to enter job related expenses. These expenses may include travel (e.g., travel time and distance for driving, mileage for driving, train/bus/plane tickets for other forms of travel, etc.), material used and its cost, any labor cost, etc.

In some embodiments, the system may generate a 1099 form for providers listing all of the income from double confirmed job payments. 1099 forms will be generated on a periodic basis, such as once a year before the federal tax filing deadline

In some embodiments, the system may also generate an expense report. The expense report nay be generated at any time for providers, either automatically or upon a user's request. This report can be generated for any job and for any time period as requested by the providers.

XII. Multivariable Feedback Mechanism

A feedback algorithm may calculate a feedback score based on feedback given by consumers or providers for several variables such as provider quality, provider time adherence, provider politeness, provider reliability, consumer payment promptness, consumer specification accuracy, consumer politeness, etc. Also, in some embodiments feedback received From providers or consumers with a history of disputes, problems & negative feedback may be highlighted and/or scored with different weighting factors.

For example, the feedback system takes a weighted mean value from the person leaving the feedback (example, people with good feedback are not affected but people with multiple bad feedback leaving feedback will not have the same weighting factor). Only a partial amount of the feedback score may be taken into the feedback calculation for such cases. This option will prevent a good consumer or service provider's reputation being destroyed by misuse of the system.

In some embodiments, this Feedback system also has tools to allow the contractor/service provider or the auction winner (consumer) to correct the bad or low feedback left by doing What is needed to correct the situation. This may include, for example, a confirmation system that will modify the feedback based on confirmation from both parties and the previously left feedback would be removed.

XII. Zip Code & Geographic Region Based Job Search Technique

The system may provide a search capability based on ZIP code or another geographic identifier such as city and/or telephone exchange. For this, the system may return all job postings that match the given ZIP code criteria.

Similarly, the system may have a geographic distance based search capability. This search may be done whether or not a given job is within certain distance (in miles) from a given ZIP code or other location. For this, the system may search all posted jobs and list the ones that fall within the given distance criteria.

XIV. Customized Job Description Templates

In some embodiments, customized job posting templates may allow the user to post details regarding the project posted, specialty, etc. There may be various templates designed for the various categories of services. These templates may also enable the uploading of pictures and suggestions as to what additional pictures should be uploaded, so that the contractor/service provider can understand the project he/she is getting into much more clearly.

There also may be tools that are embedded in web based software that allow users to draw/define the shapes and areas that a certain task needs to be performed. For example, a consumer may be allowed to draw a floor shape with dimensions that require new tiles. This will help better communicate the job needs to the provider. They call allow the contractor/service provider to calculate the square footage and intricacies with respect to the job, for example circular cuts are more expensive than straight cuts, etc. Hence the provider can get a much better idea of the project requirements and would have a higher comfort level when placing a bid.

XV. Optional Pre-Screening Process

Before registering service providers, the system may optionally pre-screen them. Prescreening may include, for example, licensing information checks, legal checks (any pending civil judgments, complaints), better business bureau checks, insurance and bonding verifications, formal education, actual work experience, criminal checks, etc. Prescreening also may include checking whether the service provider meets predetermined qualification criteria, such as licensure, specific experience or other criteria. Based on this screening, providers may be classified into multiple groups such as amateur, skilled, highly skilled, skilled but cautious (due to some past civil judgment, etc.). Consumers may use pre-screening to restrict what kind/class of providers can bid on his/her job. The prescreening may be an online process that takes in information from the job auction site and transfers it to third party vendors for checking, with results returning to the auction system

XVI. Project Management Tools Module

The system may have basic to complex project management/scheduler tools integrated. In some embodiments, these tools may be found on each user's individual page to help them keep abreast with projects and timings. The consumer may use the project management tools to schedule the various subcontractors in the right time frame as they sub contractors would be linked. The providers may use the project management tools to keep track of the various projects they currently have and win through the system. The project management tools scheduler may be linked and interfaced with the job postings auction module so that the winning provider and auction initiators schedule page will automatically update to reflect the new project that has just been won through the auction, system.

XVII. Multivariable Feedback Mechanism

An optional multivariable feedback mechanism may include evaluating both providers and consumers based on multiple variables and calculating a score based on the feedback left for each variables. Each variable may have a weighting factor. For example, there may be 3 unique variables that feedback will be left on for both the provider and the consumer. The provider and the consumer will each give a score, such as a score of 1 to 10 (1 being poor and 10 being excellent), for each of the variables based on is or her experience with the respective party in the project. For the provider to consumer feedback, the variables might be payment, personality of consumer and accuracy of the consumer's posting and project expectation. For the consumer to provider feedback, the variables might be quality of provider, reliability and time of provider and personality of provider. Each of these 3 or more variables will be individually multiplied by corresponding weighting factor and then added. The sum total will then be divided by the sum of the weighting factors used for the variables and will result in a score of 1 to 10 for the project. This may apply to both the consumer and provider. As the consumer and provider accumulate multiple projects, the score from all the projects will be added and divided by the number of projects to give an average score. If there is a dispute between the feedback left between the provider and consumer, they can both send confirmation though the feedback confirmation page and correct the feedback, thus resulting in a new feedback score and eliminating the old record.

XVIII. Customized Job Description Templates

These templates may include detailed information specific to each and every type, or at least many types, of job in the services market. Fields appropriate to the job maybe provided.

Even though techniques described in this document arc given within the context of an online blue collar job auctioning system they can be applied in broader contexts. For example:

Interactive job information request techniques can he generalized for all auctions such that it can be applied for any situation where an auctioned item (e.g., goods, jobs, etc.) description is not clear or complete enough for bidders.

Consumer driven bidder selection and background check techniques can also be generalized for all auctions. For example, a seller initiating an auction may want to sell the auctioned goods only to buyers with certain credit worthiness by using the techniques described in this memo.

Sealed-auction (and pure sealed-auction) with feedback techniques can be applied in any type of auction to fix bid-sniping and bid-gaming problems.

Similarly, end of auction bid limitation techniques may be applied in any auctioning system to overcome the bid-sniping problem

Provider alert techniques can be generalized as a generic bidder alert mechanism where a bidder will be informed about any new auction that matches his/her interest level.

Emergency auctioning techniques can also be generalized for any auction where auction initiator wants a speedy end to his/her auction.

Double Confirmed Job payment techniques may be applicable for any type of auction where auction price can change after the closure of the auction.

Income tracking techniques may also be generalized for cases where an auction initiator or a bidder generates his/her income via the auctioning, system.

XV. System Embodiments

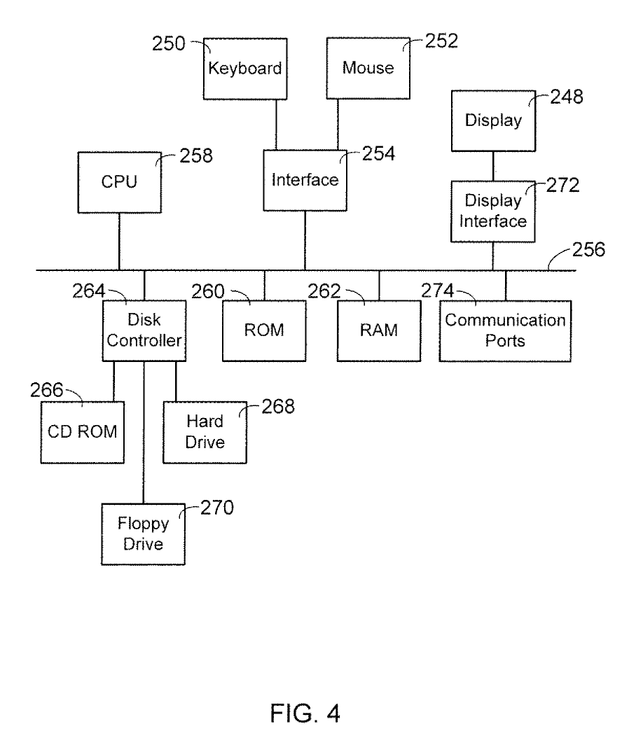

FIG. 4 is a block diagram of exemplary hardware that may be used to contain and, or implement the program instructions of a system embodiment. The instructions may be contained on any computer-readable carrier such as a computer memory device, a data signal, or other carrier of computer-readable data. Referring to FIG. 4, a bus 228 serves as the main information highway interconnecting the other illustrated components of the hardware. CPU 202 is a central processing unit of the system, performing calculations and logic operations required to execute a program. Read only memory (ROM) 218 and random access memory (RAM) 220 constitute exemplary memory devices.

A disk controller 204 may interface with one or more optional disk drives to the system bus 228. These disk drives may be external or internal memory keys, zip drives, flash memory devices floppy disk drives or other memory media such as 210, CD ROM drives 206, or external or internal hard drives 208. As indicated previously, these various disk drives and disk controllers are optional devices.

Program instructions may be stored in the ROM 218 and/or the RAM 220. Optionally, program instructions may be stored on a computer readable medium such as a floppy disk or a digital disk or other recording medium, a communications signal or a carrier wave,

An optional display interface 222 may permit information from the bus 228 to be displayed on the display 224 in audio, graphic or alphanumeric format. Communication with external devices may optionally occur using various communication ports 226. An exemplary communication port 226 may be attached to a communications network, such as the Internet or an internet.

In addition to the standard computer-type components, the hardware may also include all interface 212 which allows for receipt of data from input devices such as a keyboard 214 or other input device 216 such as a remote control, pointer and/or joystick. A display including touch-screen capability may also be an input device 216. An exemplary touch-screen display is disclosed in U.S. Pat. No. 4,821,029 to Logan et al., which is incorporated herein by reference in its entirety. In some embodiments, a computer systems may be established in a kiosk set up at a library, career link center unemployment center or other location. In alternate embodiments, a computer system may be available to an operator, and job posters or potential bidders may contact the operator through a telephone number, such as a toll free telephone number, to provide the information so that the operator may input it into the computer.

It is to be understood that the invention is not limited in its application to the details of construction and to the arrangements of the components set forth in this description or illustrated in the drawings. The invention is capable of other embodiments and of being practiced and carried out in various ways. Hence, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the embodiments described herein be regarded as including such equivalent constructions insofar as they do not depart from the spirit and scope of the present invention.

I claim:

1. An online auction system, comprising:
a first module that enables a consumer to post a job description for a job;
a second module that enables a plurality of service providers to view the job description and submit a proposal to the consumer for performing the job; and
a third module that enables the consumer to select a proposal from one of the service providers.

2. The system of claim 1 wherein the second module also enables the service providers to request additional information about the job from the consumer.

3. The system of claim 2, wherein the second module enables the service providers and consumer to interact by modifying the job description and modifying bids based on job description modifications.

4. The system of claim 1, wherein the first module provides the consumer with a job posting template.

5. The system of claim 1, further comprising a payment module that processes payment from the consumer to the service provider who submitted the selected proposal.

6. The system of claim 5, wherein the payment module releases the payment in increments after the selected service provider meets one or more milestones.

7. The system of claim 1, further comprising a feedback module that enables consumers to submit and view feedback regarding service providers.

8. A method of auctioning a local service, comprising:
receiving, from a consumer, a job description;
presenting the job description to a plurality of service providers;
receiving a plurality of service provider bids;
presenting one or more of the bids to the consumer; and
selecting a winning bid from one or more of the bids.

9. The method of claim 8, wherein the receiving a plurality of service provider bids includes:
receiving, firm a service provider, a request for additional information, delivering the request to the consumer;
receiving a revised job description or additional information from the consumer in response to the request; and
receiving a bid from the service provider based on the revised job description or additional information.

10. The method of claim 8, further comprising:
after receiving the job description, accessing a database of service providers to identify one or more qualified service providers who meet one or more criteria that relate to the job description; and
inviting the qualified service providers to submit bids in response to the job description.

11. The method of claim 10 wherein the inviting is performed via telephone or electronic mail.

12. The method of claim 8, wherein the selecting comprises:
identifying, by the system, a plurality of qualified bids from the received service provider bids;
presenting, by the systems, the plurality of qualified bids; and
receiving, from the consumer, a selection of the winning bid.

13. The method of claim 8 further comprising:
processing payment from the consumer to the selected service provider when the service provider meets a job milestone.

14. The method of claim 8, further comprising:
in the presenting, enabling the consumer to view qualifications and feedback relating to the service providers who submitted the bids; and
after the selecting, receiving from the consumer feedback relating to the selected service provider.

15. The method of claim 8, further comprising offering, to the consumer, liability insurance relating to the job description.

16. The method of claim 8, wherein the receiving includes:
receiving a consumer selection of a job description template;
receiving, via the selected template, text describing a job;
receiving, via the selected template, a photo, illustration or video describing the job; and
receiving, via the selected template, a geographic location of the job.

17. The method of claim 16, wherein the template is specific to a job category.

18. The method of claim 8, further comprising, enabling a plurality of selected service providers to search for job descriptions based on geographic location and job category.

19. A method of auctioning a local service, comprising:
receiving, from a consumer, a job description;
accessing a database of service providers to identify one or more qualified service providers who fleet one or more criteria that relate to the job description, wherein the criteria include geographic location;
inviting the qualified service providers to submit bids in response to the job description;
presenting the job description to the qualified service providers;
receiving a plurality of service provider bids, wherein at least one of the bids is a conditional bid;
receiving additional information or a revised job description from the consumer in response to the conditional bid;
receiving a conversion of the conditional bid to a binding bid;
presenting one or more binding bids to the consumer; and
selecting a winning bid from one or more of the binding bids.
